(19) United States
(12) Patent Application Publication
(10) Pub. No.: US 2004/0108386 A1
(43) Pub. Date: Jun. 10, 2004

(54) Personalized postage and methodology to stop and trace a suspicious mail piece

(76) Inventor: Mehran Randall Rasti, Baton Rouge, LA (US)

Correspondence Address: Mehran R. Rasti, 13040 Sugar Bowl Avenue, Baton Rouge, LA, 70814, US

(21) Appl. No.: 10/314,635

(22) Filed: Dec. 9, 2002

(51) Int. Cl. G06K 19/06

(52) U.S. Cl. 235/494

(57) ABSTRACT

This invention enables the mail and package delivery agencies to discourage, combat, and contain terrorist acts through postal and package delivery networks.

The invention adds a few new components, to regular postage stamps, and incorporates associated methodology for use in sorting and processing stations in order to authenticate, isolate, and track the postage to its purchaser.

Bar codes supplied on this postage contain some hidden components. At the time of sorting the mail by automated machines, computerized logic will scan and read the components contained therein. By decrypting and cross checking of the hidden components, altered or stolen postage would be identified, and the associated mail piece is ejected off distribution track, and isolated into sealed bins for further examination.

### CROSS REFERENCE TO RELATED APPLICATIONS

U.S. Pat. No. 3,565,463 Feb. 23, 1971 D. A. Taylor

U.S. Pat. No. 5,267,754 Dec. 7, 1993 Wittich Kaule

U.S. Pat. No. 5,685,570 Nov. 11, 1997 Gray, et al.

U.S. Pat. No. 3,995,741 Dec. 7, 1976 Joseph Henderson

U.S. Pat. No. 6,203,069 Oct. 15, 1999 Outwater, et al.

U.S. Pat. No. 5,128,526 Jul. 7, 1992 Yoshida

U.S. Pat. No. 3,933,094 Jan 20, 1976 Murphy, et al.

### FEDERALLY SPONSORED RESEARCH OR DEVELOPMENT

Not Applicable

### REFERENCES TO SEQUENCE LISTING, TABLE, OR COMPUTER PROGRAM TABLES

FIG. 2 contains a listing of a few sample tables used for the encryption of bar code characters.

### COMPUTER PROGRAMS

Three sample programs are supplied on the accompanying compact disk, on a folder named “Programs”, as follows:

1) MKTABLE.EXE: A sample program to make equivalency tables according to the method of claim 9. The source code of this program is included on the enclosed CD ROM, as well as in “FIG. 6”.

2) ENCRYPT.EXE: A sample program to “encrypt” a string of digits according to claim 14, using any digit-to-digit equivalency table in accordance to claim 9. The source code of this program is included on the enclosed CD ROM, as well as in “FIG. 7”.

3) DECRYPT.EXE: A sample program to “decrypt” a string of digits, using any digit-to-digit equivalency table made in accordance to claim 9. The program decrypts the postal sequence bar code digits from the face of the postage in accordance to the method outlined in claim 20. This program yields back the original digits, which were input to the above program, named “encrypt”. The source code of this program is included on the enclosed CD ROM, as well as in “FIG. 8”.

### BACKGROUND OF INVENTION

1. Field of Invention

The invention specifies a special postage stamp, and outlines accompanying procedures to identify the owner of a suspicious package or an envelop. The postage bares a reference to the identity of the person who purchased it. The invention would serve as an effective deterrent against misuse of the mail and package networks for terrorist acts, and would help to stop and contain the damage in early stages of the crime. It also serves to identify the source.

2. Status of Prior Art

The term postage refers to stamps, labels or printing placed on an item to be mailed, such as an envelope containing a letter. The postage serves as evidence of payment of the charge for mailing the item.

Postage may be purchased at the Post Office, or printed using a variety of postage meter machines, such as those supplied by Pitney Bows. They can also be bought from special vending machines, installed in Post Office buildings, or they can be generated using personal computers, and the like.

In the postage meter disclosed in the Mikhail U.S. Pat. No. 5,098,130, the meter prints on the label not only the postage, but also the name of the post office from which the piece is mailed and the date of mailing.

Of prior art interest is the Durst et al. U.S. Pat. No. 5,239,168 assigned to Pitney Bowes which discloses a postage meter that not only prints out the postage amount, and the date of mailing, but prints out in bar code form also the zip code of the destination.

The existence of this bar code printout shows that the Post Office is already equipped with bar code readers and writers, and that it has at its disposal the know how to use them. The Pusic U.S. Pat. No. 5,065,000 provides a postage meter which prints on a self-adhesive label to be attached to the piece to be mailed, a bar code that gives the destination of the piece and other data that can be read by a bar code reader at the Post Office.

The Mikhael U.S. Pat. No. 5,098,130 discloses a postage stamp in which the monetary value of the stamp is printed in bar code form to facilitate faster processing and sorting of mail pieces.

It is important to note that, to date, there have been many bar code standards. Some examples are called “code 39”, “code 93”, “code 128”, “OCR-A”, “OCR-B”, “PDF417”, and “Postnet”. Although there are many bar code standards to consider, the latter is one of the standards that U.S. Post Office has already adopted to use for Postal Bar Codes. Given the sensitive matter of National Security, the task of encoding and selection of bar code standards are left to the Post Office, Office of Homeland Security, and other Federal Agencies to deal with, and therefore, the bar code selection and standards to use, do not fall under the subject of this patent.

### SUMMARY OF THE INVENTION

The present invention provides a means to arm a conventional stamp or postage with added facilities to detect suspicious envelops or packages bearing such postage. The invention should discourage terrorist acts through the abuse of the mail system. Following is a brief explanation of this kind of a postage:

Personalized postage has two bar codes, which are pre-printed on the said postage. Among other verifiable information, the postage contains a unique sequence number, named the “postage sequence code”, that appears in encoded form, somewhere within the two bar codes. The encryption process makes forging and alteration of a valid sequence code very difficult.

At the time of purchase, the Post Office verifies the buyer's driver's license or an id card, and enters the number into a database against the “postage sequence code” being purchased. If the postage is produced through a vending machine, a credit card number plus owner's PIN is collected. If the buyer uses a PC or a Postal Permit Number, those numbers are entered into the database, instead. A three character field will indicate the type of id, credit card, or postal account number used.

Currently, the post office uses automatic scanning and computerized technology to sort and distribute the mail, based on bar code and interpretive zip code readers. This invention requires such machines to be adapted to tie into the national database of sold “postal sequence codes”, via a private network, or the Internet.

As postage is scanned by these intelligent machines, hidden codes are read and analyzed from the bar codes containing on the postage stamp.

This invention assumes that a “would be terrorist” would have to either forge, or steal postage to hide the evil act. For this reason, another database is maintained to collect the “postal sequence code” of all lost/stolen postage. For this requirement, all citizens must be instructed to guard their postage as they would their credit cards, and to report any lost or stolen postage to a toll free number, provided for such a purpose.

The lost or stolen postage data will also be available to all mail sorting machines across the nation.

When a mail piece passes through such enabled sorting machines, we would be able to:

1) Authenticate the postage via several cross checks of the components designed into such a postage, and eject the mail into sealed bins.

2) Catch and reject all altered, and lost/stolen postage (mail) into sealed bins through above inspections and comparisons.

3) Sterilize, and examine all suspicious mail, collected in the above two steps.

4) Contain the spread of germs and harmful substances from traveling all over the nation.

5) Trace and apprehend the criminal through their id/credit card numbers.

6) Discourage and prevent any kind of malicious mail through the establishment of such a deterrent.

International mail from those countries not equipped with similar technology will be treated as suspicious mail and would be subject to decontamination and manual inspection.

### BRIEF DESCRIPTION OF THE DRAWINGS

FIG. 1, displays a sample of a version of a “personalized postage”, with explanation of its components.

FIG. 2, displays sample tables of character equivalency.

FIG. 3, displays a screen showing the execution of the program named “MKTABLE.EXE”.

FIG. 4, displays a screen showing the execution of the program named “ENCRYPT.EXE”.

FIG. 5, displays a screen showing the execution of the program named “DECRYPT.EXE”.

FIG. 6, displays program code listings for the sample program named “MkTable.bas”.

FIG. 7, displays program code listings for the sample program named “Encrypt.bas”.

FIG. 8, displays program code listings for the sample program named “Decrypt.bas”.

### DETAILED DESCRIPTION

“Personalized postage” of claim 1, is designed to replace all currently used stamps, postage strips, pre-stamped envelops, and bulk and commercial mail permits. More than one of the said “personalized postage” can be produced on sheets, booklets, or rolls.

A “personalized postage” is made up of the following components, providing the following functionalities:

1) The personalized postage has an indication of the country of origin that is detectable via electronic scanners. The said components may already have been built into current postal stamps. If not, such a component should be added.

2) The personalized postage has an indication of the amount of postage paid that is detectable through optical and electronic means, and is verifiable.

3) The personalized postage has a machine verifiable “Post Office insignia”to be altered from time to time with each series of print, and to be hidden under visible light, according to claim 17. This is printed in special inks sensitive to different light wavelengths, partially, in the invisible range. This means a mark or two in the visible ink colors, with couple or more markings in the invisible light ranges. The purpose is to make this difficult to forge.

4) The personalized postage has a machine verifiable “cancellation area” to prevent a postage from being used more than once, in accordance to claim 16. This is a rectangular area whose coordinates and reflective properties are known to the scanning and sorting machines, sorting the mail. The act of postage cancellation can consist of simply inking over the rectangle, to cover or discolor the special ink marks of claim 16, with ink or bleach, such that it exhibits detectible changes in the reflective properties of the said rectangle, when scanned electronically.

5) A design incorporating the combinations of claim 17 with claim 16, is possible in such a way to cancel the “Post Office insignia”, instead, using bleach or ink to change the reflective and the wave length properties of light emitting back from the “Post Office insignia”.

6) In addition to above components described so far, personalized postage is characterized further, with the existence of encoded bar codes, where its partially encrypted character components are keyed together in such a way to follow the designed embedded logic and pattern matching algorithems. One of the many possible architectures showing such logic and scheme is described in FIG.-1. The given character interdependencies and schemes designed into personal postage bar codes, enables an authentication capability that can be altered from time to time, with each series (date) of stamps printed. Claims 4 through 17, along with claim 20, makes this possible. The specified design, when used in conjunction with the presented methodology and procedures in sorting the mail, enables the capability of extracting the “suspicious” mail.

7) Starting from the top bar code, as presented in FIG.-1, the personal postage has the following structure:

a. Starting from left, the first two positions are reserved for an encryption table name, in accordance to claim 6. These names can be alpha, numeric, or a combination of the two. There are 100 table names possible using numeric digits by themselves. Using alpha characters by themselves, we will have another 676 names possible. Using the combination of alpha and numbers will make well over 1000 names possible. This is documented as claim 2. The sheer number of table name possibilities, enables for the table name selection process to be linked to some aspect of the computer system time, causing table name alterations to vary with the time. Therefore the postage a buyer receives at different times will a different “postal sequence codes”, even with using the same id or credit card. This would defeat forging efforts and enhances security greatly.

b. The 3^{rd} and 4^{th} position of the top row bar code is reserved for a print “series” number of the postage stamp, according to claim 7. For example, 01 is used for the stamps printed in April 2004, and the like. Here again, well over one thousand possibilities exist.

c. The next 4 digits, following the “series code”, is the first 4 characters of “postal sequence code”, according to claim 8. This code is first encrypted using the table name according to claim 6, the code equivalencies of claim 9, and is printed on the postage according to claim 15.

d. The first 5 characters of the second row bar code, according to claim 10, is also processed and imprinted on the personal postage according to claim 15. This piece, along with the first 4 characters of claim 8, results in a 9 character “postal sequence code”. Combining this with the two character “series code” of claim 7, and the two character table name of claim 6, makes 13 alpha-numeric positions available for issuance of many combinations. Since, according to claim 6, each roll, book, or batch of postage is sold using the same “postal sequence code”, it would take a long time to exhaust the available combinations of “postal sequence codes”, and to have to start over. In addition, each postal commercial user, using postal accounts and permit numbers, can use the same “postal sequence code”. To enhance the security, “postal sequence codes” should be issued with variable gaps in between sequence numbers, in accordance to a pre-set formula, such that outguessing of any other valid “postal sequence code”would be almost impossible to guess.

e. The 6^{th} and 7^{th} characters in the bottom row of bar codes represent the two character table name of claim 6, repeated. This is a trick to throw off any would be forger into guessing the next valid bar code number. The two positions should be allocated to “check-sum digit” algorithms, explained below, when the selected bar code algorithm, according to claim 5 calls for more than 1 position for such a function. Claim 5 exists because of design sensitivity to National Security issues and existing U.S. Post Office standards in place. It is for this reason that the exact design of these two positions should remain as “floating”.

f. The last position of the bottom bar code is reserved for “check sum character” according to claim 12. This is a special value designed as part of “safer” bar code standards, to cause rescanning and correction of digits received out of a bar code. For reasons mentioned under claim 5, no methods are presented or claimed in this application.

The process explained under the heading of “Summary of Invention”, outlines the specifics of how the “id” tract information of postage buyers are entered into a national database. The customer's collected number is entered into a computer database, along with a three character source code. This code indicates what the collected number represents; such as the type of the credit card used, the Postal Account type, or the letter D, plus a two letter state code for driver's license numbers.

The lost or stolen “postage sequence numbers” are also reported and gathered in a similar database. At mail sorting facilities nationwide, both of databases are made available to modified sorting machines. Such machines scan and read all specified components of “personal postage”, and will compare the mail bearing such a postage with both of the said databases. This will enable the sort machines to eject any letter with a forged, stolen, or suspicious nature to be ejected off the distribution stream, and into sealed bins for treatment, and further inspection.

All of the above components and methods mentioned provides a “protective” and “tracing” layer, which does not exist at the present time to the best of author's knowledge. The other positive impact of such a traceable postage stamp, is its preventative effect in discouraging even the thought of terrorizing the postal system.

Of course, just like the “airport checks”, this process cannot guarantee a total safety; nevertheless, it provides a degree of a very much needed protection to the public at large, of course for a small price. A price that is much easier to bear, when compared against the loss of innocent lives and high cost of clean up.

I claim:

1. A postal stamp, having all of the required attributes satisfying all current U.S. Postal requirements and standards, that is uniquely personalized, verifiable, and traceable to its owner through its supplied components, using automated means.

2. A postal stamp according to claim 1, contains a “postal sequence code”, to uniquely identify it.

3. The “postal sequence code” of claim 2 is the same on all of the stamps contained in a roll, bundle, book, sheet, or permit, as sold.

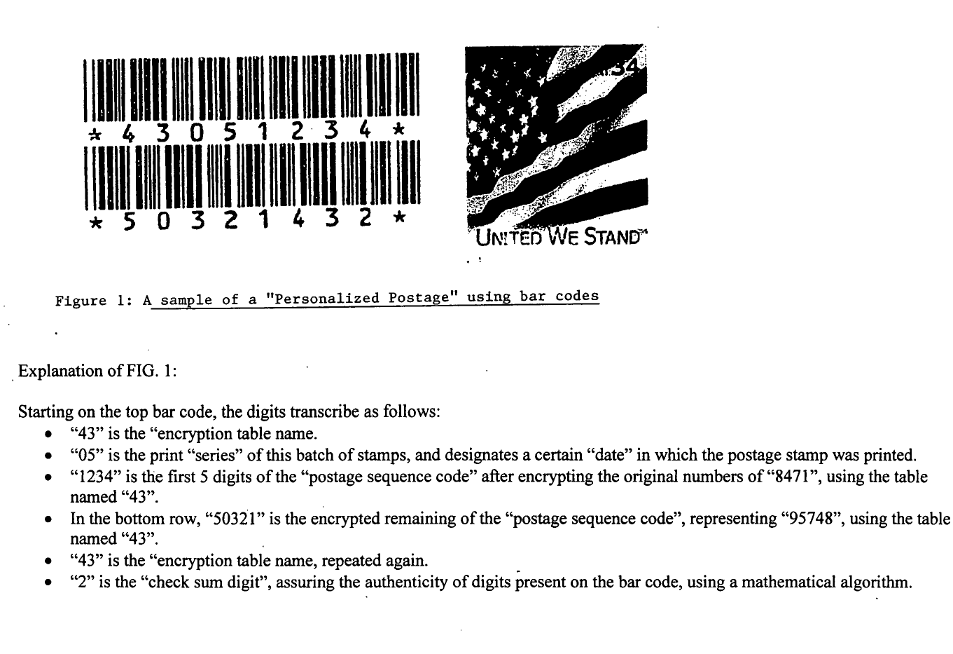

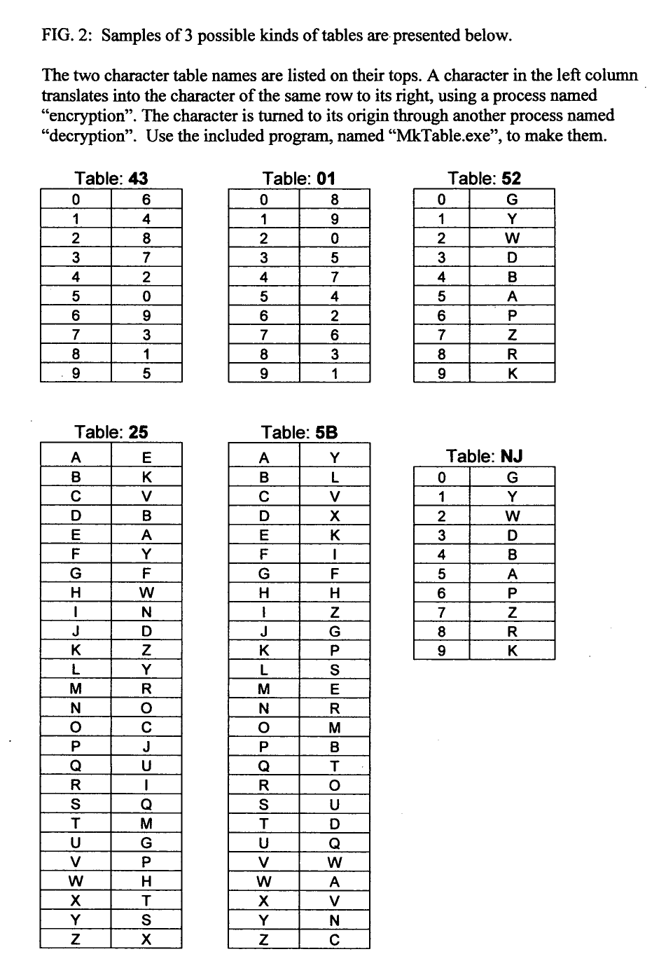

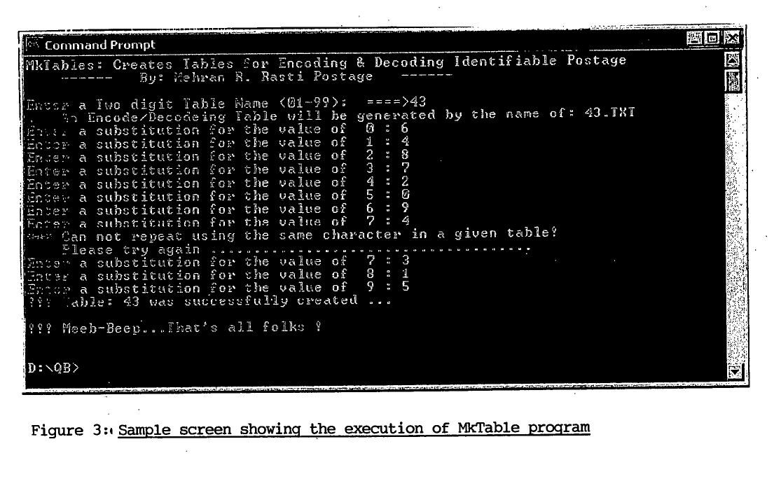

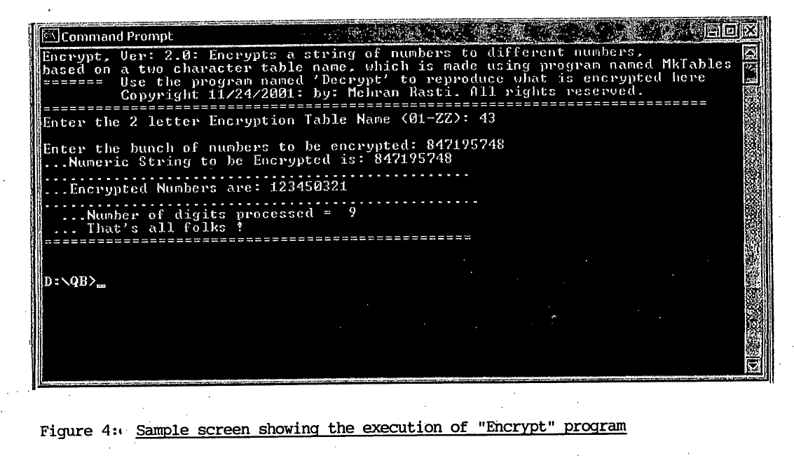

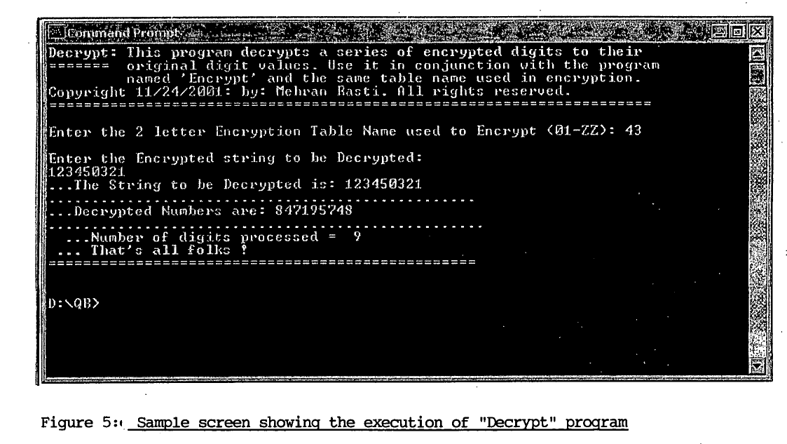

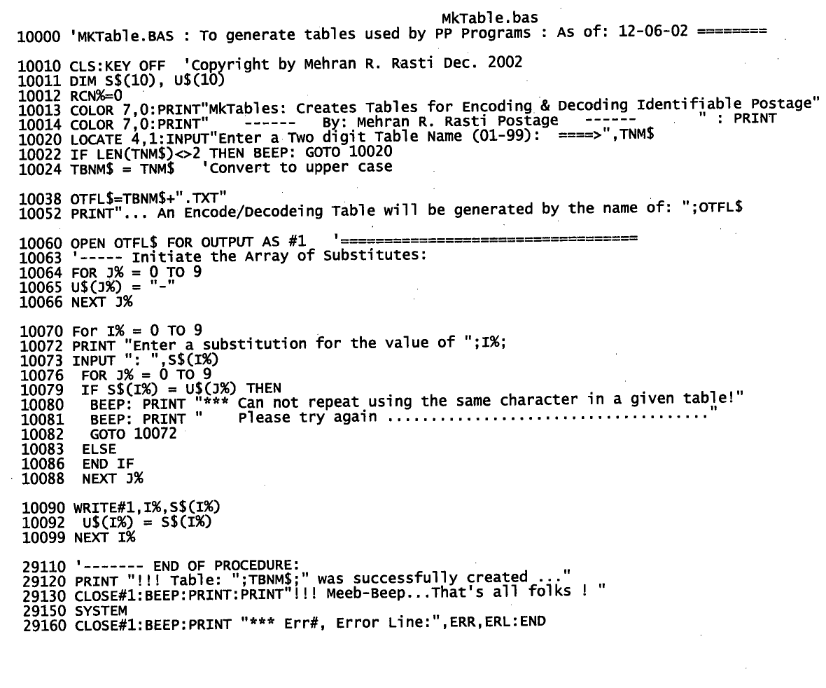

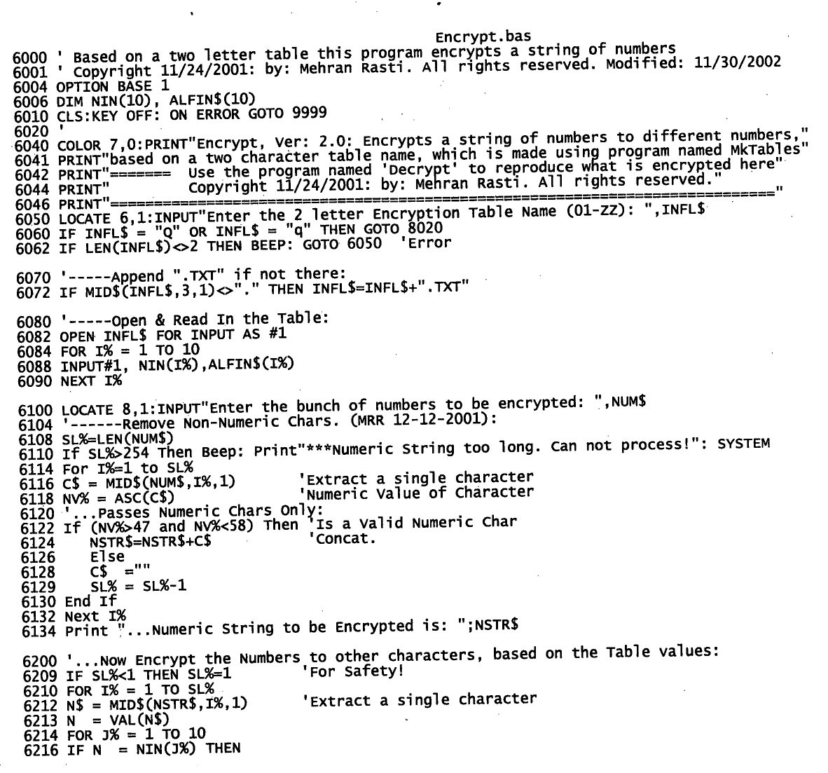

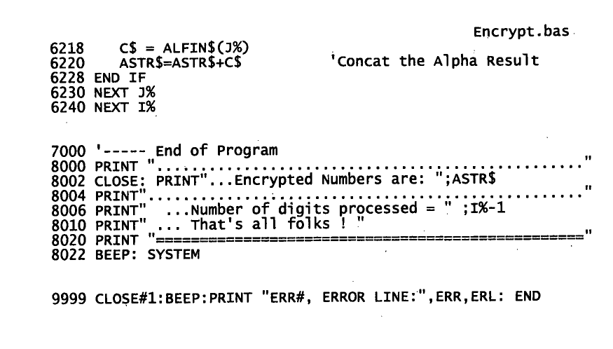

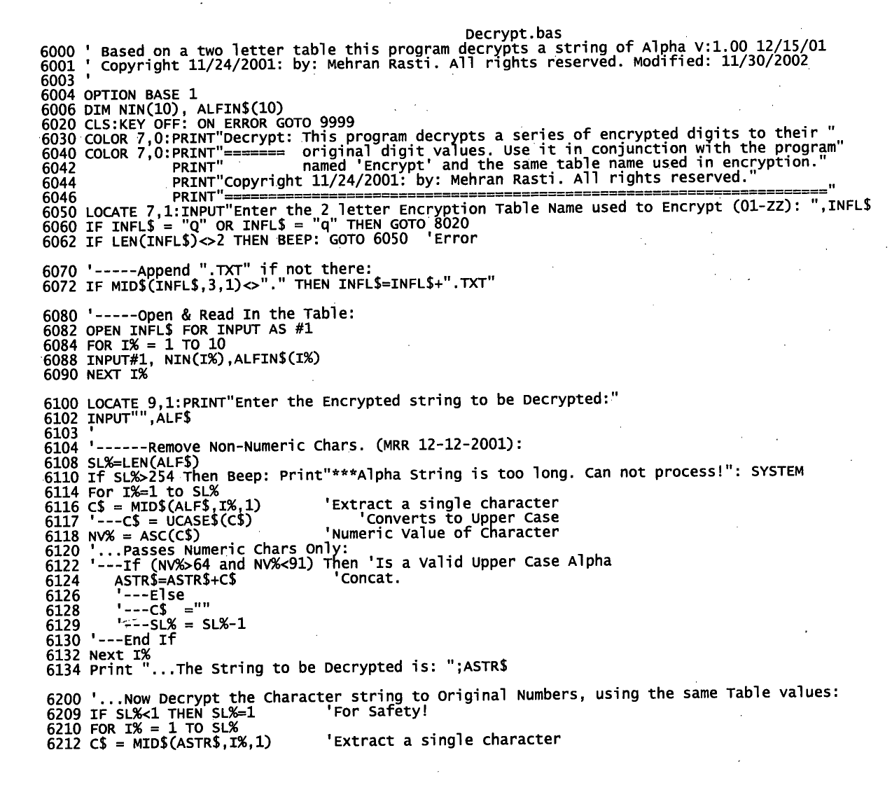

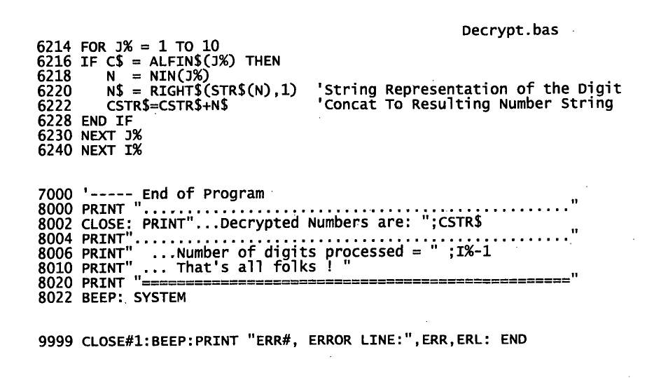

4. A postal stamp according to claim 1, contains two bar codes, both of which are situated to the left of the postage picture, or emblem, according to FIG. 1.

5. The bar codes according to claim 4 are generated and printed using U.S. Post Office approved algorithms and methods.

6. The first bar cod of claim 4 contains a two character code indicating the table name to be used in encrypting numbers within the bar code of claim 4.

7. The first bar cod of claim 4 contains a two character code indicating the “series”or the date code in which the postage was printed.

8. The first bar code of claim 4 contains the first 4 characters of the “postage sequence code” of claim 2.

9. A method by which a named table, according to claim 6, is constructed. A table contains a series of equivalencies mapping either a digit to a different digit, a digit to a letter of the alphabet, an alpha character to a different alpha character, or an alpha into a digit, in a way that no element of a given table is a duplicate. FIG.-2 exhibits a few samples of such tables.

10. The second bar code of claim 4 contains the remaining characters of the “postage sequence code” of claim 2.

11. The second bar code of claim 4 may also contains the table name according to claim 6, repeated.

12. The second bar code of claim 4 also contains a “check-sum” character used for verification of the bar code scanning and reading process.

13. The “postage sequence code of claim 2 is a unique numeric, alpha, or alpha-numeric string value for a given date code of claim 7.

14. A method by which the “postal sequence code” of claim 2, is encrypted using a table according to claim 9. A sample encryption program is supplied.

15. A method by which the output of method 14 is turned into a bar code format, and printed, in accordance to claim 5.

16. A postal stamp according to claim 1, bears a “cancellation area” by which the postage is voided via electronic or optical means, after a one time use.

17. A postal stamp according to claim 1, contains a “Post Office insignia”, similar to markings found on dollar notes, that is hard to forge. This is located near the face of the stamp, or to its side.

18. A postal stamp according to claim 1, contains a designated bar code space of no less than one inch in length, but large long enough to accommodate printing of bar codes of claim 2.

19. The postal stamp of claim 1, comprising of a sheet of printable material having two surfaces; The opposite side being coated with a bonding material, and the other bearing an indication of the amount of postage paid, and the country of origin. The printed side is machine readable. A second sheet may adhere to the adhesive side of the printed sheet, in order to temporarily cover the adhesive material from bonding elsewhere, until its time of use.

20. A method through which the “postal sequence code” of claim 2, is decrypted at mail or package sorting facility, using a table of method 9, utilizing computerized scanning and sorting machines. A sample decryption program is supplied to illustrate this method.
